(19) United States
(12) Patent Application Publication
(10) Pub. No.: US 2023/0421940 A1
(43) Pub. Date: Dec. 28, 2023

(54) ARTICULATED EAR TIP

(71) Applicant: APPLE INC., Cupertino, CA (US)

(72) Inventors: Geng Luo, Santa Clara, CA (US); Shota Aoyagi, San Francisco, CA (US); Timothy Emmott Torres, San Francisco, CA (US)

(73) Assignee: APPLE INC., CUPERTINO, CA (US)

(21) Appl. No.: 18/205,733

(22) Filed: Jun. 5, 2023

Related U.S. Application Data
(60) Provisional application No. 63/366,827, filed on Jun. 22, 2022.

(51) Int. Cl. H04R 1/10

(52) U.S. Cl. CPC H04R 1/1016; H04R 1/1041; H04R 1/1075

(57) ABSTRACT

An in-ear headphone that includes: a device housing that defines an interior cavity; a primary acoustic port formed through the device housing; an acoustic driver disposed within the device housing and aligned to emit sound through the primary acoustic port; and a deformable ear tip having a sound channel formed through its length and coupled to the device housing such that the sound channel is aligned with the primary acoustic port, wherein an angle of the ear tip with respect to the primary acoustic port can changed around an indefinite number of axes to change a position and angle of the ear tip relative to the device housing.

### CROSS-REFERENCES TO RELATED APPLICATIONS

This application claims priority to U.S. Provisional Patent Application No. 63/366,827 filed on Jun. 22, 2022, which is incorporated herein by reference in its entirety for all purposes.

### BACKGROUND

Earphones are a type of portable listening device that is intended to be positioned substantially within a user's ear. They can be used with a wide variety of electronic devices such as portable media players, smart phones, tablet computers, laptop computers and stereo systems. Earphones, which can also be referred to as ear-fitting headphones, include both in-ear headphones and earbuds. In-ear headphones, which are sometimes referred to as canal phones, are small headphones that include a deformable ear tip or similar structure that is inserted in the ear canal itself. Earbuds are small headphones that fit within a user's outer ear facing the ear canal but do not include an ear tip or other structure that is inserted into the ear canal.

Despite the growing popularity of earphones, new and improved earphone designs are continuously being sought.

### BRIEF SUMMARY

Various embodiments of the invention pertain to in-ear earphones that include a deformable ear tip that is coupled to the earphone housing in a manner that allows the ear tip to be moved, with respect to the housing, in different directions so that the ear tip can be more easily aligned with and fit into the ear canal of the ear of a user.

In some embodiments, an in-ear headphone includes: a device housing that defines an interior cavity; a primary acoustic port formed through the device housing; an acoustic driver disposed within the device housing and aligned to emit sound through the primary acoustic port; and a deformable ear tip having a sound channel formed through its length and coupled to the device housing such that the sound channel is aligned with the primary acoustic port, wherein an angle of the ear tip with respect to the primary acoustic port can changed around an indefinite number of axes to change a position and angle of the ear tip relative to the device housing.

In some embodiments, an in-ear headphone includes: a device housing including a speaker housing that defines an interior cavity and a stem extending away from the speaker housing portion; a primary acoustic port formed through the speaker housing; an acoustic driver disposed within the interior cavity and aligned to emit sound through the primary acoustic port; and a deformable ear tip having a sound channel formed through its length and coupled to the speaker housing such that the sound channel is aligned with the primary acoustic port, wherein an angle of the ear tip with respect to the primary acoustic port can changed around an indefinite number of axes to change a position and angle of the ear tip relative to the device housing.

In still other embodiments, an in-ear headphone includes: a device housing that defines an interior cavity; a primary acoustic port formed through the device housing; an acoustic driver disposed within the interior cavity and aligned to emit sound through the primary acoustic port; wireless communication circuitry disposed within the interior cavity; a wireless antenna; a rechargeable battery disposed within the interior cavity; a processor disposed within the interior cavity and operably coupled to the rechargeable battery and to the wireless communication circuitry; and a deformable ear tip having a sound channel formed through its length and coupled to the device housing such that the sound channel is aligned with the primary acoustic port, wherein an angle of the ear tip with respect to the primary acoustic port can changed around an indefinite number of axes to change a position and angle of the ear tip relative to the device housing.

In various implementations, in-ear headphones disclosed herein can include one or more of the following features. The ear tip can be coupled to the device housing by a ball and socket connector. The ear tip can have first and second opposing ends. The first end can be sized and shaped to be inserted into an ear canal of a user and the ball portion of the ball and socket connector can disposed at the second end. The ball portion can include an opening at its distal end that is fluidly coupled to the sound channel and that, when the ear tip is coupled to the device housing, is aligned with the primary acoustic port. The ear tip can be coupled to the device housing by a compound joint. The compound joint can comprise a baffle. The device housing can include a speaker housing and an elongated stem extending away from the speaker housing. The speaker housing can have a generally ovular shape. The speaker housing and elongated stem can form a monolithic housing structure with a substantially seamless appearance.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified lateral view illustration of a human ear into which in-ear headphones according to embodiments disclosed herein can be fit;

FIG. 2 is a simplified perspective view of an in-ear headphone that can include an articulating ear tip according to some embodiments;

FIG. 3 is a simplified diagram depicting examples of movement of an ear tip on an in-ear headphone according to some embodiments;

FIG. 4 is a simplified illustration of an in-ear headphone with an articulating ear tip according to some embodiments where the articulating ear tip is disconnected from the in-ear headphone;

FIG. 5 is a simplified illustration of an in-ear headphone with an articulating ear tip according to some additional embodiments; and

FIGS. 6A and 6B are simplified illustrations depicting examples of movement of the ear tip relative to the body of the in-ear headphone shown in FIG. 5 according to some embodiments.

### DETAILED DESCRIPTION

The present invention will now be described in detail with reference to certain embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known details have not been described in detail in order not to unnecessarily obscure the present invention.

### Anatomy of a Human Ear

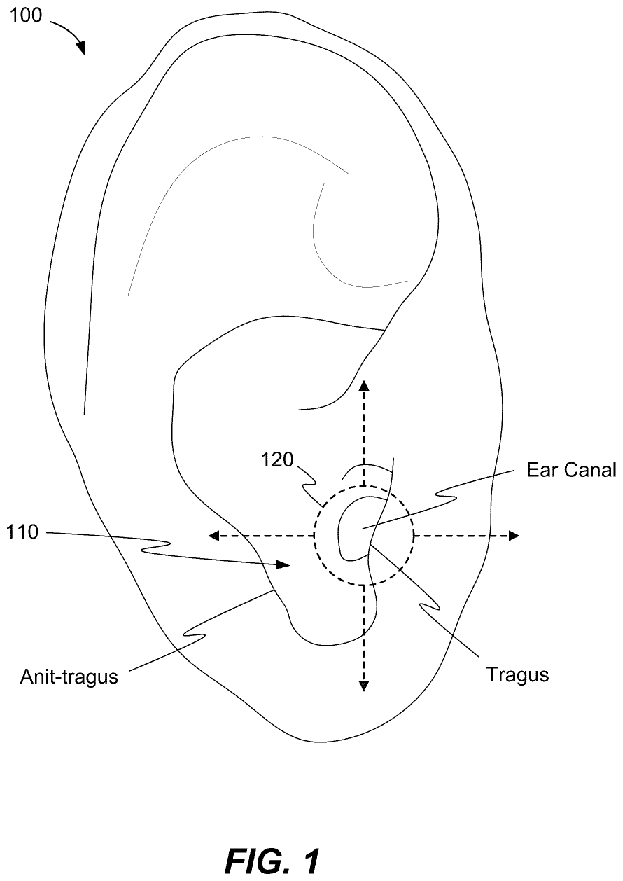

In order to better appreciate and understand the present invention, reference is first made to FIG. 1, which is a simplified lateral view illustration of a typical human ear 100 into which in-ear headphones according to embodiments disclosed herein can be fit. As shown in FIG. 1, human ear 100 includes a targus portion and an anti-targus portion in an opposing relationship on opposite sides of the ear canal. In this typical human ear 100, the targus and anti-targus define a channel 110 adjacent to the ear canal. Earphones, such as in-ear headphones, generally include a housing that is sized and shaped to fit within the volume neighboring channel 110 such that the housing fits within and is secured between the tragus and anti-tragus and the ear tip extends into the ear canal. As represented by dashed lines 120, however, the position of the ear canal can vary greatly and is often spaced several millimeters or more in any of the various directions depicted by dashed lines 120.

Traditional in-ear headphones have a fixed relationship between the body (primary housing) of the in-ear headphone and its ear tip. Some such earphones have a primary body that has a generally circular cross-sectional shape. The circular shape of the earphone body can allow the earphone to be moved around around 110 to get improved alignment with the ear tip and the ear canal. Earphones with a generally circular primary body can suffer from a rather poor fit within the ear of some users. To obtain an improved fit, many earphones include a primary body that has an ovular cross-sectional shape. While such ovular earphones have can have an improved, more secure fit around the channel 110 of many users, the earphones generally cannot be moved around channel 110 very much, especially for smaller ears, which can make it difficult to get the ear tip to align with the ear canal to achieve an ideal fit.

In-Ear Headphones with an Articulating Ear Tip

Embodiments of in-ear headphones described herein solve the above-described problem by including an ear tip that can have its position adjusted with respect to the in-ear headphone body. Thus, in embodiments presented herein, the ear tip position is essentially decoupled from to earphone body which enables the ear tip to be have good alignment with the ear canal even in earphones that have an ovular body.

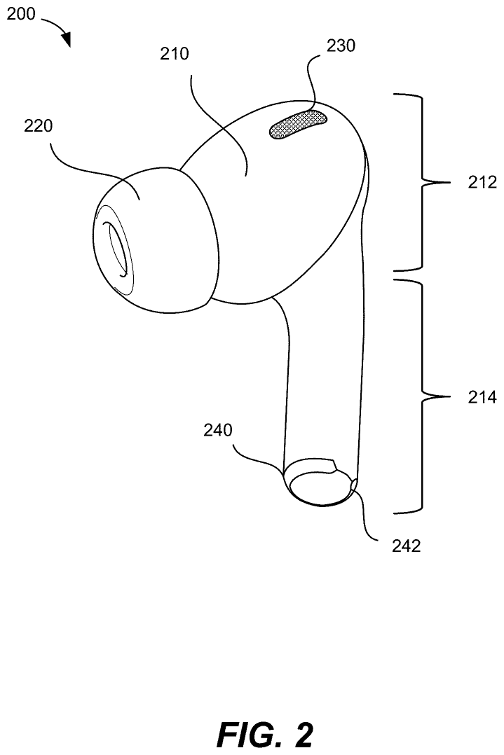

FIG. 2 is a simplified perspective view of an example of an in-ear headphone 200 that can include an articulating ear tip according to some embodiments. Earphone 200 includes a housing 210 and an ear tip 220 that can direct sound from an internal audio driver (e.g., a speaker) out of housing 210 and into a user's ear canal. Housing 210 can be made from, for example, a hard radio frequency (RF) transparent plastic such as acrylonitrile butadiene styrene (ABS) or polycarbonate. In some embodiments, housing 210 can be made from one or more components that can be bonded together (e.g., with tongue and groove joints and an appropriate adhesive) to form a monolithic housing structure with a substantially seamless appearance.

In some embodiments housing 210 can be formed of a seemingly monolithic outer structure without any obvious seams or rough edges. Housing 210 can form a shell that defines an interior cavity (not shown) in which the various components of earphone 200 are positioned. For example, enclosed within housing 210 can be a processor or other type of controller, one or more computer-readable memories, wireless communication circuitry, an antenna, a rechargeable battery, power receiving circuitry and various sensors, such as an accelerometer, a photodetector, force and touch sensors and the like, none of which are shown in any of FIG. 2. Housing 210 can also house an audio driver (i.e., a speaker) and one or more microphones. The speaker and one or more microphones can each be positioned within housing 210 at locations adjacent to audio openings that extend through housing 210 to allow the speaker and the one or more microphones to transmit and receive audio waves through the housing.

Housing 210 can include a speaker housing 212 and a stem 214 extending from the speaker housing 212 at an angle. The speaker housing 212 portion of housing 210 is sized and shaped to fit within and be secured behind channel 110 by the tragus and anti-tragus. In the depicted embodiment, speaker housing 212 can have a generally ovular shape that enables the speaker housing to be fit securely within channel 110.

Speaker housing 212 defines a primary acoustic port (not visible in FIG. 2) and can include one or more additional audio ports, such as base port and a control leak. Some or all of such audio openings can be covered by a mesh. For example, as shown in FIG. 2, a mesh 230 can be disposed over vent formed through speaker housing 212. The vent can be acoustically coupled to a back volume of the speaker housing to provide improved acoustic performance of the earphone.

In some embodiments stem 214 can be substantially cylindrical in construction along a portion of its length and can include a planar region (not shown) that does not follow the curvature of the cylindrical construction. While not shown, the planar region can indicate an area where in-ear headphone 200 is capable of receiving user input. For instance, a user input can be inputted by squeezing the stem at the planar region or sliding a finger along a portion of the planar region. Stem 214 can also include electrical contacts 240 and 242 for making contact with corresponding electrical contacts in charging case that can store and charge a pair of in-ear headphones 200. Electrical contacts 240, 242 provide a physical interface that can be electrically coupled with corresponding electrical contacts in a corresponding charging case. It is to be understood that embodiments are not limited to the particular shape and format of the housing 210 depicted in FIG. 2. For example, in some embodiments the housing does not include a stem or similar structure and in some embodiments an anchor or other structure can be attached to or extend away from the housing to further secure the earbud to a feature of the user's ear.

Ear tip 220 can be coupled to speaker housing 212 such that the ear tip 220 receives sound emitted by the audio driver through the primary acoustic port. Ear tip 220 can include an outer surface made primarily from a deformable material and can be sized and shaped to fit within a user's ear canal. For example, ear tip 220 can be inserted within the ear canal and can direct the received sound into the ear canal. In some embodiments, ear tip 220 can be removably attached to speaker housing 210 enabling different sized ear tips to be attached to the in-ear headphone 200 to better accommodate different sized ear canals.

Importantly, and as described in more detail below, in embodiments disclosed herein, ear tip 220 is coupled to speaker housing 212 in a manner that allows the ear tip to be moved, with respect to the housing, in different directions so that the ear tip can be more easily aligned with and fit into the ear canal of the ear of a user.

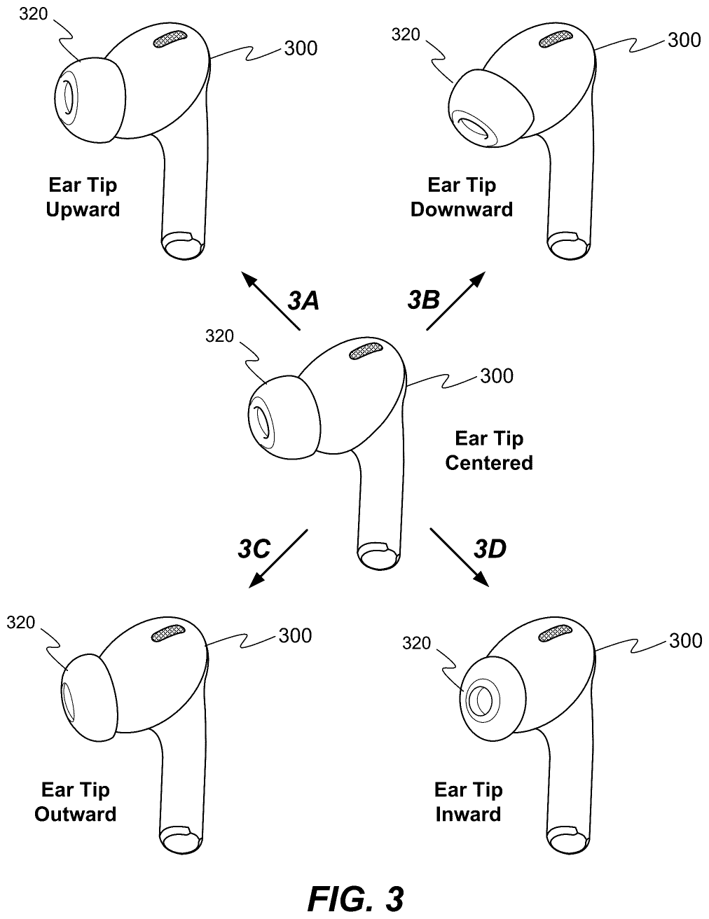

FIG. 3 is a simplified diagram depicting examples of movement of an ear tip on an in-ear headphone 300 according to some embodiments. In-ear headphone 300 can be representative of in-ear headphone 200 discussed above. As shown in FIG. 3, in-ear headphone 300 is depicted with its ear tip 320 in five different positions. In the center of the figure, in-ear headphone 300 is depicted with ear tip 320 in a generally centered position. In the upper left of FIG. 3, as denoted by arrow 3A, in-ear headphone 300 is depicted with ear tip 320 angled upwards while in the upper right, as denoted by arrow 3B, in-ear headphone 300 is depicted with ear tip 320 angled downwards. In the two views of in-ear headphone 300 depicted at the bottom of FIG. 3, in-ear headphone is depicted with ear tip 320 angled to the left (arrow 3C) and right (arrow 3D), respectively.

Allowing ear tip 320 to be adjusted according to the different positions and angles shown in FIG. 3 (as well as any direction in between the depicted positions), enables the ear tip to have improved alignment with the ear canals of different users for whom the position of their ear canal can vary from each other as discussed with respect to FIG. 1. The improved alignment can, in turn, result in an improved fit and comfort for the user and can also result in an improved seal for better audio quality and better noise cancellation features.

1. Ear Tip with a Ball and Socket Joint

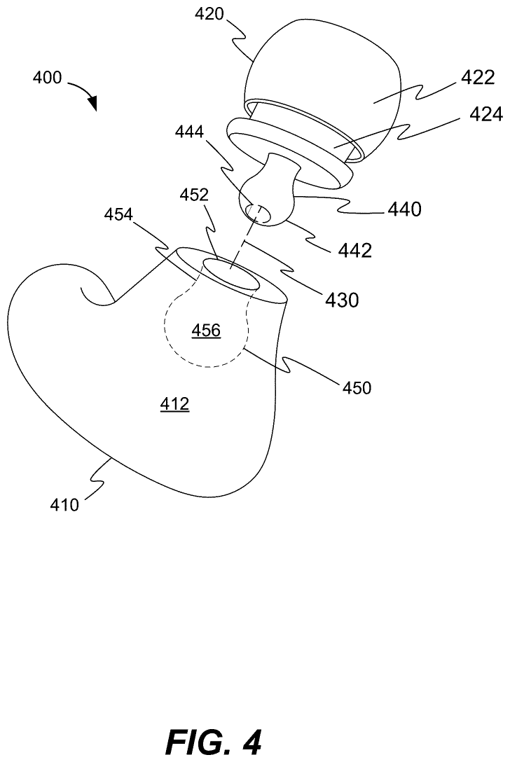

FIG. 4 is a simplified illustration of an in-ear headphone 400 according to some embodiments that can be representative of in-ear headphones 200 and 300. As shown in FIG. 4, in-ear headphone 400 includes housing 410 and a removable ear tip 420 shown in FIG. 4 in a detached position spaced apart from housing 410.

Housing 410 can form a shell that defines an interior cavity (not shown) in which the various components of in-ear headphone 400 are positioned as discussed above with respect to housing 210. Also, similar to housing 210, housing 410 can include a speaker housing 412 and a stem 414 extending away from the speaker housing 412 at an angle. The speaker housing portion 412 of housing 410 can be sized and shaped to fit within and be secured near channel 110 (FIG. 1) by the tragus and anti-tragus. In the depicted embodiment, speaker housing 412 can have a generally ovular shape that enables the speaker housing to be fit securely around channel 110.

Ear tip 420 can direct sound from an internal audio driver (e.g., a speaker) out of housing 410 and into a user's ear canal. Towards that end, ear tip 420 can include a deformable outer body 422 that is sized and shaped to fit within a human ear canal and conform under pressure to the shape of the ear canal. An inner body 424 defines a sound channel (not shown) through a length of ear tip 420 that, when ear tip 420 is properly connected to housing 410, delivers sound received from a speaker within speaker housing to the user.

Ear tip 420 can include a ball connector 440 at one end that is sized and shaped to be mated with a socket connector 450 formed in speaker housing 412. Ball connector 440 includes an opening 444 centered at the exterior surface of bulbous portion 442. Opening 444 is part of the ear tip sound channel (not shown besides opening 444) that extends through ear tip 420. When ball connector 440 is mated with socket connector 450, opening 444 aligns with a primary acoustic port (not shown) within speaker housing 412 that directs sound from an audio driver (i.e., speaker) to the ear tip sound channel.

Ball connector 440 and socket connector 450 cooperate to enable ear tip 420 to be removably attached to housing 410 by asserting a force along axis 430 that pushes ball connector 440 into an opening 452 and past a neck portion 454 of the socket connector 450 until the end bulbous portion 444 of the ball connector 440 rests within a cup portion 456 of the socket connector 450. To facilitate the connection, at least one of ball connector 440 or socket connector 450 can be made from a plastic or similar material that can compress sufficiently to enable the bulbous end 442 of the ball connector to be squeezed into and through opening 452 of socket connector 450. Once mated, the ball connector 440 can be rotated and angled within socket connector 450 around an indefinite number of axes to change the position and angle of ear tip 420 in the up, down, left and right directions as depicted in FIG. 3 as well as in any direction in between those four primary directions.

Ball connector 440 can then be removed from socket connector 450 by applying a force along axis 430 in the opposite direction (i.e., by pulling the ball connector out of the socket connector) as used to connect the two components.

2. Ear Tip with a Flange

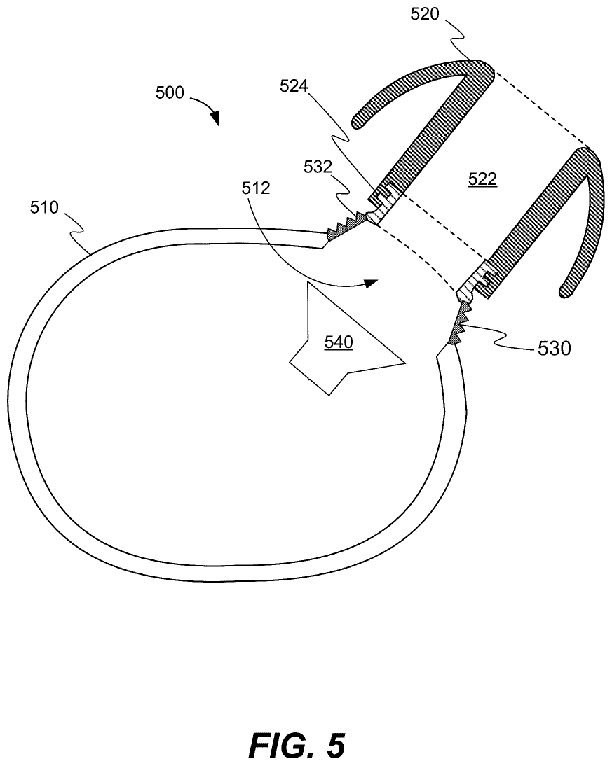

FIG. 5 is a simplified illustration of an in-ear headphone 500 in accordance with additional embodiments. In-ear headphone 500 includes an ear tip 520 that is connected to an housing 510 by a compound joint 530 that allows the ear tip 520 to be aligned in the different positions and directions as discussed above with respect to FIG. 3. As with the earphones described above, an audio driver 540 can be positioned within housing 510 and aligned to emit sound through a primary acoustic port 512 to ear tip 520. The ear tip defines a sound channel 522 that extends through a length of the ear tip to direct sound from the audio driver 540 directly into a user's ear canal.

Compound joint 530 can be positioned between housing 510 and the bulk of ear tip 520. Compound joint 530 can include an annular baffle 532 that can be made from a flexible material, such as silicone or a rubber, and aligned to allow sound generated by audio driver 540 to pass through baffle 532 into sound channel 522. Baffle 532 can contract and expand as necessary to allow ear tip 520 to be bent or angled in a desired direction, such as discussed above with respect to FIG. 3.

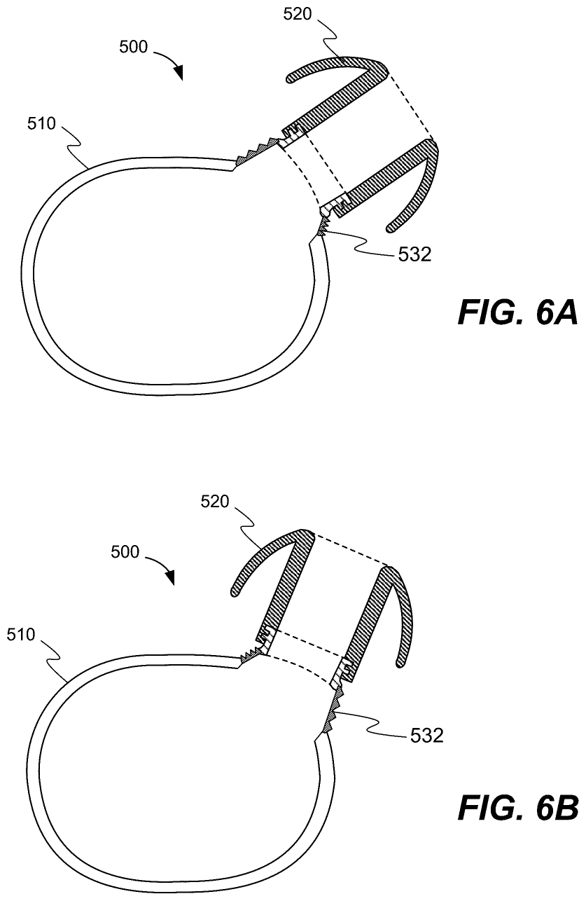

To illustrate, reference is made to FIGS. 6A and 6B, which are simplified cross-sectional views depicting in-ear headphone 500 with ear tip 520 angled in two different directions. In FIG. 6A, ear tip 520 is angled towards the right side of the page. To accommodate the changed position of the ear tip, baffle 532 is stretched along the portion at the top left of the figure and compressed along a portion at the bottom right of the figure. In FIG. 6B, ear tip 520 is angled towards the top of the page. To accommodate the changed position of the ear tip, baffle 532 is compressed along the portion at the top left of the figure and stretched along a portion at the bottom right of the figure. While FIGS. 6A and 6B depict ear tip 520 moved into two different positions, compound joint 530 allows the ear tip to be moved around an indefinite number of axes to change the position and angle of ear tip 520 in the up, down, left and right directions as depicted in FIG. 3 as well as in any direction in between those directions.

Referring back to FIG. 5, in some embodiments, ear tip 520 can include a rigid portion 524 at an attachment end of the deformable ear tip that has a pair of recesses or openings (not shown) along an inner edge enabling a spring or similar connector to be latched onto the rigid portion so that ear tip 520 can be removably attached to housing 510. One example of such an attachment mechanism is disclosed in commonly assigned U.S. Pat. No. 10,986,433, which is incorporated by reference herein in its entirety. The compound joint 530 can either be a part of housing 510 such that the rigid portion attaches to the compound joint (e.g., as shown in FIG. 5), or can be part of ear tip 520 and thus be between the rigid portion 524 of ear tip 520 and the deformable ear tip.

### ADDITIONAL EMBODIMENTS

The foregoing description, for purposes of explanation, used specific nomenclature to provide a thorough understanding of the described embodiments. However, it will be apparent to one skilled in the art that the specific details are not required in order to practice the described embodiments. For example, while several specific embodiments are described above with respect to earbuds that include a stem portion (e.g., housing portion 214) extending away from a speaker housing portion (e.g., housing portion 212) embodiments are not limited to earbuds having a stem portion or similar feature. In some embodiments, the earbud housing can comprise a bulbous or similar housing structure that does not include a stem.

Thus, the foregoing descriptions of the specific embodiments described herein are presented for purposes of illustration and description. They are not intended to be exhaustive or to limit the embodiments to the precise forms disclosed. Also, while different embodiments of the invention were disclosed above, the specific details of particular embodiments may be combined in any suitable manner without departing from the spirit and scope of embodiments of the invention. For example, while embodiments described above referenced certain components as being within one or the other of housing portion 610, 620, it is to be understood that such was for illustrative purposes only. In other embodiments components of an earbud can be arranged differently than in the examples above. As illustrative examples, any of the battery, wireless circuitry, processor, antenna, microphones and other components can be located in either the stem portion or the speaker housing portion. Further, it will be apparent to one of ordinary skill in the art that many modifications and variations are possible in view of the above teachings.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

Finally, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An in-ear headphone comprising:
a device housing that defines an interior cavity;
a primary acoustic port formed through the device housing;
an acoustic driver disposed within the device housing and aligned to emit sound through the primary acoustic port; and
a deformable ear tip having a sound channel formed through its length and coupled to the device housing such that the sound channel is aligned with the primary acoustic port, wherein an angle of the ear tip with respect to the primary acoustic port can changed around an indefinite number of axes to change a position and angle of the ear tip relative to the device housing.

2. The in-ear headphone set forth in claim 1 wherein the ear tip is coupled to the device housing by a ball and socket connector.

3. The in-ear headphone set forth in claim 2 wherein: the ear tip has first and second opposing ends; the first end is sized and shaped to be inserted into an ear canal of a user; and the ball portion of the ball and socket connector is disposed at the second end.

4. The in-ear headphone set forth in claim 3 wherein the ball portion includes an opening at its distal end that is fluidly coupled to the sound channel and that, when the ear tip is coupled to the device housing, is aligned with the primary acoustic port.

5. The in-ear headphone set forth in claim 1 wherein the ear tip is coupled to the device housing by a compound joint.

6. The in-ear headphone set forth in claim 5 wherein the compound joint comprises a baffle.

7. The in-ear headphone set forth in claim 1 wherein the device housing comprises a speaker housing and an elongated stem extending away from the speaker housing.

8. The in-ear headphone set forth in claim 7 wherein the speaker housing has a generally ovular shape.

9. The in-ear headphone set forth in claim 7 wherein the speaker housing and elongated stem form a monolithic housing structure with a substantially seamless appearance.

10. An in-ear headphone comprising:
a device housing comprising a speaker housing that defines an interior cavity and a stem extending away from the speaker housing portion;
a primary acoustic port formed through the speaker housing;
an acoustic driver disposed within the interior cavity and aligned to emit sound through the primary acoustic port; and
a deformable ear tip having a sound channel formed through its length and coupled to the speaker housing such that the sound channel is aligned with the primary acoustic port, wherein an angle of the ear tip with respect to the primary acoustic port can changed around an indefinite number of axes to change a position and angle of the ear tip relative to the device housing.

11. The in-ear headphone set forth in claim 10 wherein the ear tip is coupled to the device housing by a ball and socket connector.

12. The in-ear headphone set forth in claim 11 wherein: the ear tip has first and second opposing ends; the first end is sized and shaped to be inserted into an ear canal of a user; and the ball portion of the ball and socket connector is disposed at the second end.

13. The in-ear headphone set forth in claim 12 wherein the ball portion includes an opening at its distal end that is fluidly coupled to the sound channel and that, when the ear tip is coupled to the device housing, is aligned with the primary acoustic port.

14. The in-ear headphone set forth in claim 11 wherein the ear tip is coupled to the device housing by a compound joint.

15. The in-ear headphone set forth in claim 14 wherein the compound joint comprises a baffle.

16. An in-ear wireless headphone comprising:
a device housing that defines an interior cavity;
a primary acoustic port formed through the device housing;
an acoustic driver disposed within the interior cavity and aligned to emit sound through the primary acoustic port;
wireless communication circuitry disposed within the interior cavity;
a wireless antenna;
a rechargeable battery disposed within the interior cavity;
a processor disposed within the interior cavity and operably coupled to the rechargeable battery and to the wireless communication circuitry; and
a deformable ear tip having a sound channel formed through its length and coupled to the device housing such that the sound channel is aligned with the primary acoustic port, wherein an angle of the ear tip with respect to the primary acoustic port can changed around an indefinite number of axes to change a position and angle of the ear tip relative to the device housing.

17. The in-ear wireless headphone set forth in claim 16 wherein the ear tip is coupled to the device housing by a ball and socket connector.

18. The in-ear headphone set forth in claim 17 wherein: the ear tip has first and second opposing ends; the first end is sized and shaped to be inserted into an ear canal of a user; and the ball portion of the ball and socket connector is disposed at the second end.

19. The in-ear headphone set forth in claim 16 wherein the ear tip is coupled to the device housing by a compound joint.

20. The in-ear headphone set forth in claim 19 wherein the compound joint comprises a baffle.
